(19) United States
(12) Patent Application Publication
(10) Pub. No.: US 2026/0307447 A1
(43) Pub. Date: Oct. 8, 2026

(54) VEHICLE SUSPENSION COMPONENT AND INERTIAL MEASUREMENT UNIT

(71) Applicant: Fox Factory, Inc., Duluth, GA (US)

(72) Inventors: Isaac Chapluk Garcia, Chula Vista, CA (US); Bobby Lee Smith, JR., Alpine, CA (US)

(73) Assignee: Fox Factory, Inc., Duluth, GA (US)

(21) Appl. No.: 19/717,368

(22) Filed: Jun. 23, 2026

Related U.S. Application Data
(62) Division of application No. 18/421,754, filed on Jan. 24, 2024.

(51) Int. Cl. B60G 17/016

(52) U.S. Cl. CPC B60G 17/016; B60G 2400/10

(57) ABSTRACT

Disclosed herein is a suspension control method, apparatus, and system for utilizing virtual vehicle dynamics data. The suspension control method includes receiving vehicle dynamics data from an inertial measurement unit (IMU) which is disposed at a first location on a vehicle. Next, virtual vehicle dynamics data is generated where the virtual vehicle dynamics data corresponds to information which would be received from IMU provided IMU was disposed at a second location on the vehicle. Suspension control data configured for use by a suspension component is then generated. The suspension control data is generated using virtual vehicle dynamics data. Finally, suspension control data is output to the suspension component.

### CROSS-REFERENCE TO RELATED APPLICATIONS

This application is a Divisional application and claims priority to and benefit of co-pending U.S. patent application Ser. No. 18/421,754, filed Jan. 24, 2024, entitled “VEHICLE SUSPENSION COMPONENT AND INERTIAL MEASUREMENT UNIT” by Isaac Chapluk Garcia et al., assigned to the assignee of the present application, having Attorney Docket No. FOX-0220US, which is herein incorporated by reference in its entirety.

### BACKGROUND ART

As suspension systems become more complex, it is useful to find better ways to control them.

### BRIEF DESCRIPTION OF THE DRAWINGS

The accompanying drawings, which are incorporated in and form a part of this specification, illustrate embodiments of the present technology and, together with the description, serve to explain the principles of the present technology.

FIG. 1 is a perspective view of an inertial measurement unit, in accordance with embodiments of the present invention.

FIG. 2 is a perspective view line drawing of a vehicle with multiple potential IMU locations, in accordance with embodiments of the present invention.

FIG. 3 is a diagram of a suspension control system that outputs to a suspension component, in accordance with embodiments of the present invention.

FIG. 4 is an example lookup table used in the generation of the suspension control data, in accordance with embodiments of the present invention.

FIG. 5 is a diagram of a suspension control system that receives input from a UI and has an output to a suspension component, in accordance with embodiments of the present invention.

FIG. 6 is a diagram of a suspension control system that receives input from a UI and has an output to at least one suspension component, in accordance with embodiments of the present invention.

FIG. 7 is a diagram of a suspension control system where the processor integral with the ECU, in accordance with embodiments of the present invention.

FIG. 8 is a diagram of a suspension control system where the processor is integral with the IMU, in accordance with embodiments of the present invention.

FIG. 9 is a diagram of a suspension control system where the processor is integral with the suspension component, in accordance with embodiments of the present invention.

FIG. 10 is a diagram of a suspension control system with a first IMU communicatively coupled to a first processor, and a second IMU communicatively coupled to a second processor, in accordance with embodiments of the present invention.

FIG. 11 is a diagram of a suspension control system with a first IMU and a second IMU communicatively coupled to a first processor and a second processor, in accordance with embodiments of the present invention.

### DETAILED DESCRIPTION OF THE EMBODIMENTS

The detailed description set forth below in connection with the appended drawings is intended as a description of various embodiments of the present invention and is not intended to represent the only embodiments in which the present invention is to be practiced. Each embodiment described in this disclosure is provided merely as an example or illustration of the present invention, and should not necessarily be construed as preferred or advantageous over other embodiments. In some instances, well-known methods, procedures, and objects have not been described in detail as not to unnecessarily obscure aspects of the present disclosure.

The present detailed description will begin with a brief overview of the present embodiments, followed by a description of the structure of embodiments of the present invention, and will conclude with a description of the operation of embodiments of the present invention.

### BRIEF OVERVIEW

Embodiments of the present invention utilize a single IMU, placed at a particular location on a vehicle, to generate information as if the IMU was placed at a different location on the vehicle. The data measured by the IMU is also used to generate control data for adjusting the vehicle's suspension. Moreover, embodiments of the present invention, as are described below in detail, emulate having the IMU placed, for example, at the vehicle's center of gravity. Hence, embodiments of the present invention eliminate the requirement to attach the IMU to the vehicle at any specific, or potentially impractical, location. Additionally, in embodiments of the present invention, measurements from a single IMU attached to the vehicle are used to generate control data which conventionally required attaching a plurality of IMU's to the vehicle at different locations and then receiving and processing the measurements from the plurality of IMU's. As a result, embodiments of the present invention generate suspension control data while eliminating the need for a plurality of IMU's to be attached to different locations on the vehicle.

### STRUCTURE OF EMBODIMENTS OF THE PRESENT INVENTION

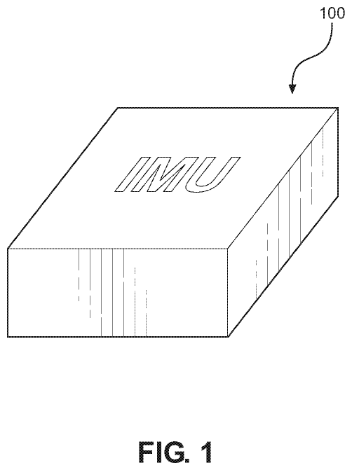

Referring now to FIG. 1, a schematic perspective view of an inertial measurement unit 100 is provided in accordance with embodiments of the present invention. An inertial measurement unit (IMU) is used to measure, for example, linear and rotational acceleration. An IMU such as, for example, Acceleration sensor MM7.10 from Bosch Sensortech GmbH of Reutlingen, Germany, can be utilized in accordance with various embodiments of the present invention. It should be noted that embodiments of the present invention are well suited to use with any of the numerous IMUs models provided by a variety of IMU manufacturers and suppliers.

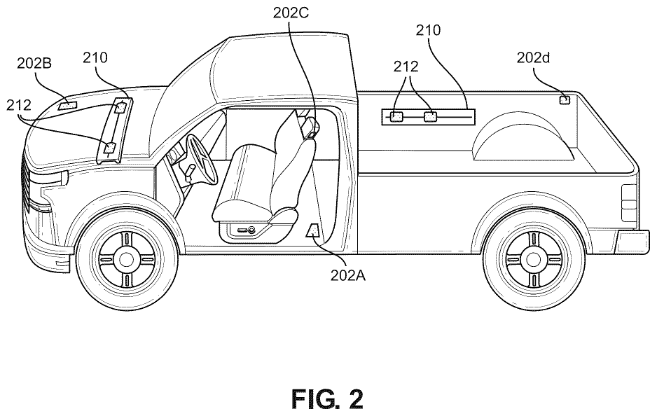

When IMU 100 is attached to a vehicle, such as, for example, but not limited to, a car, bike, snowmobile, truck, or other vehicle, IMU 100 measures vehicle dynamics for that vehicle. For purposes of the present application, it should be understood that vehicle dynamics data comprises, for example, the linear and rotational acceleration data measured by IMU 100. Therefore, if IMU 100 is coupled to, for example, a truck (hereinafter vehicle 200), as depicted in FIG. 2, IMU 100 measures the linear and rotational acceleration experienced by vehicle 200. More specifically, and as will be discussed in detail below, IMU 100 measures the linear and rotational acceleration experienced by vehicle 200 at the precise location where IMU 100 is attached to vehicle 200.

Surge, sway, heave, pitch, yaw, and roll are terms used to describe a vehicle's behavior. While a vehicle is undergoing surge, sway, heave, pitch, yaw, roll, or some combination thereof, adjustments to the vehicle's suspension can greatly impact the vehicle's performance and the rider's comfort and ability to control the vehicle.

FIG. 2 is a perspective view line drawing of a vehicle 200 with multiple potential

IMU locations 202A-202D (collectively referred to as 202). Potential IMU locations 202A-202D, are examples of positions where IMU 100 could be attached to vehicle 200. It should be understood that these locations are shown for the sake of illustration and are not intended to be limiting. Potential IMU location 202A is intended to represent the center of gravity for vehicle 200. It will be understood that the location of the center of gravity will vary for each vehicle. Further, the location of the center of gravity will vary based on a number of factors including, but not limited to, the type of vehicle, the cargo and or vehicle.

In various embodiments, IMU 100 is attached or mounted to a vehicle in a fixed position. In other embodiments, IMU 100 is attached to a vehicle, for example, on a sliding bracket 210, or similar feature, such that the physical location of IMU 100, with respect to the vehicle, can be adjusted. In one such embodiment, sensors 212 on sliding bracket 210, or a similar feature, are utilized to measure the location of IMU 100 with respect to vehicle 200. In one embodiment of the present invention, a plurality of predetermined IMU locations are configured for placement of IMU 100. In one such embodiment, a sensor 212, switch, or the like, is used such that indicate the location of IMU 100 on vehicle 200.

As mentioned above, it should be noted that an IMU only locally measures dynamics data for a vehicle. That is to say, IMU 100 measures the linear and rotational acceleration occurring at the precise location at which the IMU is coupled to the vehicle. For example, if IMU 100 is coupled to the front right hood of vehicle 200, for example location 202B of FIG. 2, then the measured vehicle dynamics data correspond specifically to the linear and rotational acceleration experienced by the front right hood of vehicle 200 (i.e., location 202B). Similarly, if IMU 100 is coupled to location 202C of vehicle 200, for example the head rest of the driver's seat, IMU 100 will measure vehicle dynamics data corresponding to the linear and rotational acceleration experienced at the head rest of vehicle 200.

Because an IMU only locally measures dynamics data for a vehicle, it is often desired to physically locate an IMU at the vehicle's center of gravity. Locating the IMU at the vehicle's center of gravity, allows the IMU to measure dynamics data which is sometimes considered to be the most accurate representation of dynamics data for a vehicle. While there are many situations that would benefit from having the vehicle dynamics data for the center of gravity of a vehicle, there are often space limitations that prevent IMU 100 from being precisely placed at the vehicle's center of gravity. In cases where IMU 100 is unable to be accurately placed at the center of gravity, the measured vehicle dynamics data will differ from the linear and rotation acceleration experienced at the vehicle's center of gravity.

For example, when comparing vehicle dynamics data measured by IMU 100 at location 202A compared to location 202D during, for instance, a turn, IMU 100 placed at location 202D will measure different linear and rotational acceleration values than the values measured by IMU 100 if placed at location 202A. In some cases, the location of IMU 100 can cause measured values to be exaggerated compared to what the rider of the vehicle, the vehicle's center of gravity, or other location of note, is experiencing. Similarly, depending on the location of IMU 100, the measured dynamics data for a vehicle can be understated.

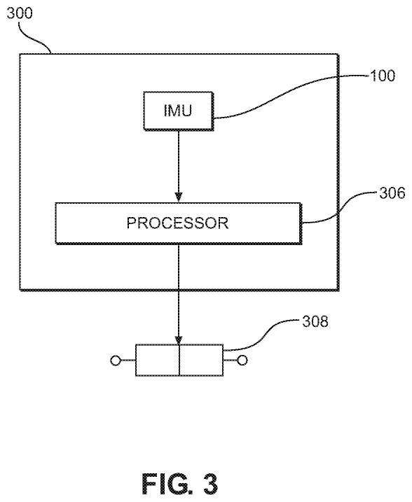

With reference now to FIG. 3, embodiments of the present invention provide a suspension control method that generates and then utilizes “virtual vehicle dynamics data”. As described in detail below, various embodiments of the present invention receive vehicle dynamics data from IMU 100 of FIG. 1. In such embodiments, IMU 100 is disposed at a first location on vehicle 200 of FIG. 2. The present method then generates “virtual” vehicle dynamics data corresponding to information which would be received from IMU 100, provided IMU 100 was disposed at a second location on vehicle 200. Various embodiments of the present invention generate suspension control data configured for use by a suspension component of vehicle 200 using the virtual vehicle dynamics data. In embodiments of the present invention, the suspension control data is output to the suspension component.

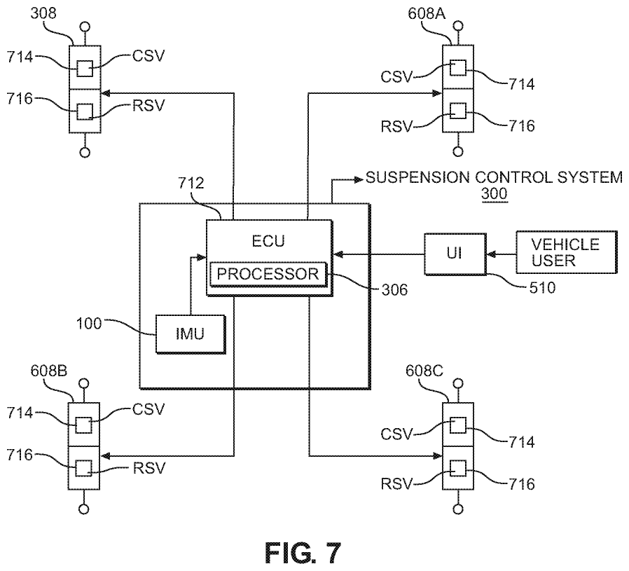

Referring still to FIG. 3 and also to FIG. 7, in embodiments of the present invention vehicle dynamics data measured by IMU 100 is processed by a processor 306. Processor 306 of the various embodiments is configured to receive the vehicle dynamics data from IMU 100. Processor 306 generates suspension control data and outputs the suspension control data to a suspension component 308 of vehicle 200. Embodiments of the present invention are well suited to having processor 306 receive information from IMU 100 via a wired connection, a wireless connection (e.g., Bluetooth), or a similar connection method.

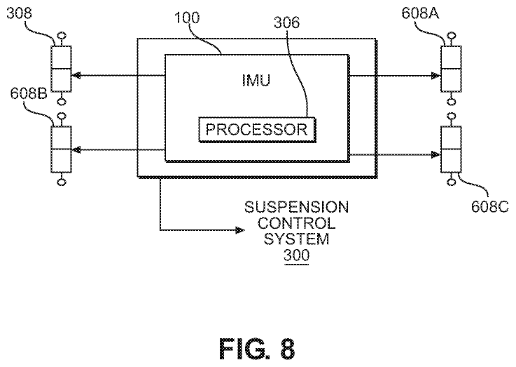

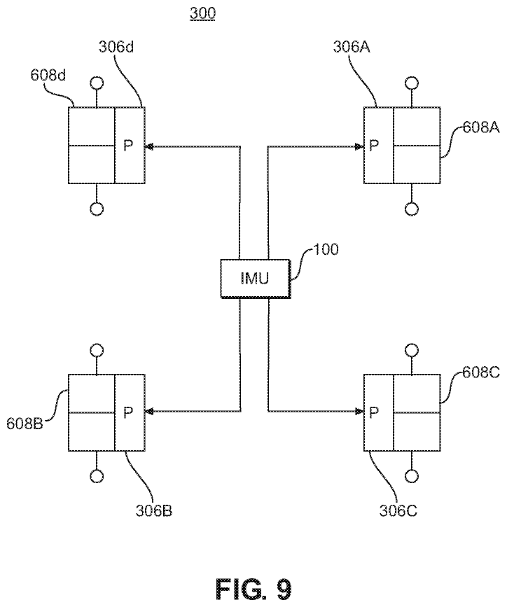

Referring still to FIG. 3 and FIG. 7, in one embodiment, processor 306 is integral with ECU 712 as depicted in FIG. 7. It should be understood that embodiments of the present invention are well suited to having processor 306 disposed other than integral with ECU 712. As shown in FIG. 8, in various embodiments of the present invention, processor 306 is integral with IMU 100. Moreover, as shown in FIG. 9, in various embodiments of the present invention, processors (306a-306d) are integral with respective suspension components (shown as 608a-608d) of vehicle 200. As will be described below in detail, in various embodiments of the present invention utilizing multiple processors, the multiple processors are not required to be located in a similar respective location. That is, in one embodiment, one processor (e.g., processor 306 of FIG. 8) is integral with ECU 712, while another processor (e.g., processor 306a of FIG. 9) is integral with IMU 100.

In embodiments of the present invention, processor 306, regardless of the location of processor 306, is configured to receive vehicle dynamics data from IMU 100 which is disposed at a first location on vehicle 200.

### Operation of Embodiments of the Present Invention

Referring to FIGS. 1-3, in embodiments of the present invention, processor 306 generates “adjusted vehicle dynamics data”. For purposes of the present application, “adjusted vehicle dynamics data” refers to information which would be received from IMU 100 provided IMU 100 was disposed at a second location on vehicle 200. In other words, in various embodiments, when IMU 100 is coupled to a first location on vehicle 200, such as, for example, location 202D, processor 306 adjusts the vehicle dynamics data received from IMU 100 to generate adjusted vehicle dynamics data. In embodiments of the present invention, the adjusted vehicle dynamics data correspond to measurements which would be received from IMU 100 provided IMU 100 was instead coupled to vehicle 200 at a second location, such as, for example, location 202C.

As an example, and as stated above, it is often not practical to locate IMU 100 at, for example, the vehicle's center of gravity (location 202A). In such a situation, and in accordance with embodiments of the present invention, IMU 100, is, instead, coupled to vehicle 200 at location 202C. In embodiments of the present invention, processor 306 adjusts the vehicle dynamics data received from IMU 100 located at location 202C, and generates adjusted vehicle dynamics data which correspond to the vehicle dynamics data which would have been received from IMU 100 if IMU 100 was instead coupled to vehicle 200 at location 202A.

Referring now to FIGS. 1-3, in embodiments of the present invention, processor 306 generates adjusted vehicle dynamics data by transforming the received the vehicle dynamics data into adjusted vehicle dynamics data. As an example, in one embodiment, IMU 100 is coupled to vehicle 200 at location 202C and provides the measured vehicle dynamics data to processor 306. In one embodiment, processor 306 defines the received vehicle dynamics data as having a position of (X, Y, Z) with respect to vehicle 200. Processor 306 utilizes the difference between location 202C and 202A to transform the received vehicle dynamics data into adjusted vehicle dynamics data. As a result, in embodiments of the present invention, processor 306 receives vehicle dynamics data, at a given time, from an IMU located, for example, at location 202C of vehicle 200. Processor 306 then generates “adjusted vehicle dynamics data” such as, for example, the linear and rotational acceleration experienced by vehicle 200, at the same given time, at location 202A. In one embodiment of the present invention, processor 306 generates the adjusted vehicle dynamics data, from the received vehicle dynamics data, in near real time.

With reference now to FIGS. 1-4, in various embodiments of the present invention, processor 306 generates the adjusted vehicle dynamics data using a lookup table 400. More specifically, in various embodiments, the present invention first determines the “offset” or “variance” between IMU measurements taken from different locations on a vehicle. In one embodiment, a vehicle is subjected to, for example, a particular motion such as, but not limited to, a linear and rotational acceleration. As an example, in one embodiment, measurements from an IMU located proximate the vehicle's center of gravity are compared with measurements from one or more IMUs located elsewhere on the vehicle. In so doing present embodiments of the invention ascertain the correlation between IMU location on a vehicle and the offset in IMU measurements. In various embodiments of the present invention such a location correlation for IMU measurement offset values is determined empirically, via interpolation, via extrapolation or various combination of the three approaches. In various embodiments, the location correlation for IMU measurement offset values is stored in a lookup table 400 and accessible by processor 306. In various embodiments, a mesh topography is created wherein each location on the mesh has a corresponding IMU measurement offset value. Additionally, in various embodiments, the present invention determines the correlation between IMU location on a vehicle and the offset in IMU measurements for a predetermined number of locations where an IMU is likely to be attached to the vehicle.

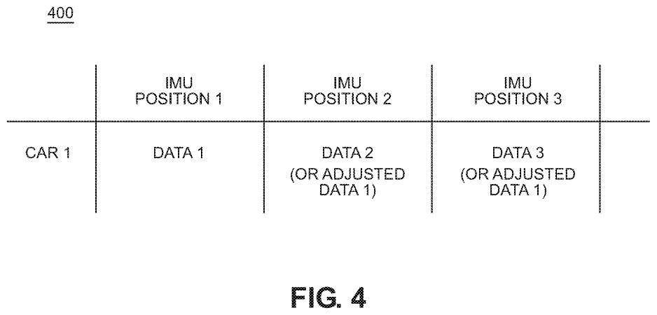

Referring still to FIGS. 1-4, in embodiments of the present invention, measurements from a single IMU mounted anywhere on vehicle 200, in combination with lookup table 400, are used to determine a corresponding IMU measurement which would be received had the single IMU been attached elsewhere on vehicle 200. Lookup table 400 includes a plurality of potential IMU locations (such as those shown in at least FIG. 2), which represent virtual IMU locations. In the example shown in at least FIG. 4, IMU position 1 is the physical location of IMU 100, while IMU position 2 and IMU position 3 are virtual IMU positions. As such, in this example data 1 is actual measured vehicle dynamics data, while data 2 and data 3 are two sets of adjusted vehicle dynamics data corresponding to two respective locations on vehicle 200.

In various embodiments of the present invention, measurements from multiple IMUs are used to generate the correlation between IMU location on a vehicle and the offset in IMU measurements, as represented in lookup table 400. In such an embodiment, Data 1 of lookup table 400 represents measurements taken by IMU 100 at position 1 of vehicle 200. Data 2 of lookup table 400 represents measurements (or offsets to Data 1) which would have been measured by IMU 100 if IMU 100 had been located at position 2 of vehicle 200. Similarly, Data 3 of lookup table 400 represents measurements (or offsets to Data 1) which would have been measured by IMU 100 if IMU 100 had been located at position 3 of vehicle 200. Examples of IMU position 2 and IMU position 3 are shown, at least, in FIG. 2. In such a case, data 1 and data 2 are two sets of vehicle dynamics data and data 3 is a set of adjusted vehicle dynamics data. As a result, embodiments of the present invention utilize a single IMU, placed at a particular location on a vehicle, to generate information as if the IMU was placed at a different location on the vehicle.

In one embodiment, lookup table 400 is based on the vehicle specifications. For example, a lookup table configured for a truck would differ from a lookup table configured for a snowmobile. Similarly, a lookup table configured for a vehicle model of type A would differ from a lookup table configured for a vehicle model of type B.

For purposes of the present application, it should be understood that the term adjusted vehicle dynamics data may also be referred to as, for example, virtual data, virtualized data, emulated data, spoofed data, and the like.

By generating the adjusted vehicle dynamics data, embodiments of the present invention more accurately determine the appropriate suspension adjustments for a vehicle. For example, even if IMU 100 is located proximate the center of gravity of vehicle 200, embodiments of the present invention can generate adjusted vehicle dynamics data corresponding to the regions proximate each wheel of vehicle 200. Utilizing the adjusted vehicle dynamics data, processor 306 generates suspension control data configured for use by, for example, a suspension component 308. In various embodiments, processor 306 outputs the suspension control data to suspension component 308.

With reference still to FIG. 3, the suspension control data is used to adjust a damping characteristic of suspension component 308 of vehicle 200. In one embodiment, the damping characteristic is a compression characteristic, a rebound characteristic, or a combination thereof. For additional detail and description of a shock absorber/damper, see, as an example, U.S. Pat. No. 10,576,803 the content of which is incorporated by reference herein, in its entirety. For additional detail and description of position-sensitive shock absorber/damper, see, as an example, U.S. Pat. No. 6,296,092 the content of which is also incorporated by reference herein, in its entirety.

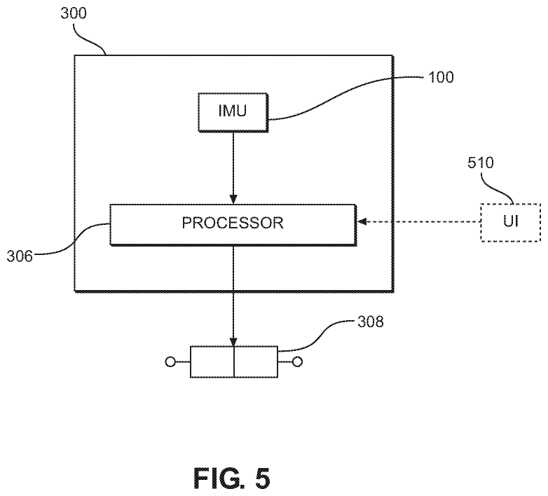

With reference next to FIG. 5, a schematic diagram of a suspension control system 300 that receives input from a user interface (UI) input receiver 510 and has an output to a suspension component 308 is shown in accordance with embodiments of the present invention.

UI input receiver 510 is communicatively coupled with processor 306. UI input receiver 510 is configured to receive input data and communicate the input data with processor 306. In other words, various embodiments of the present invention include a UI that an end user can interact with, through which an end user can manually change settings. Examples of such settings include the virtual IMU location, which IMU is prioritized (in the case of multiple IMU's), which set of vehicle dynamics data or adjusted vehicle dynamics data is used in specific situations, etc.

In one embodiment, the IMU settings are displayed on a graphical user interface (GUI) and/or human machine interface (HMI) such as an infotainment system HMI/GUI (e.g., in-vehicle infotainment (IVI) system, or the like) where the IVI system or other device will provide an ability for the user to modify the IMU settings. Further discussion and examples of an IVI control system and componentry are described in U.S. Pat. No. 10,933,710, the content of which is incorporated by reference herein, in its entirety.

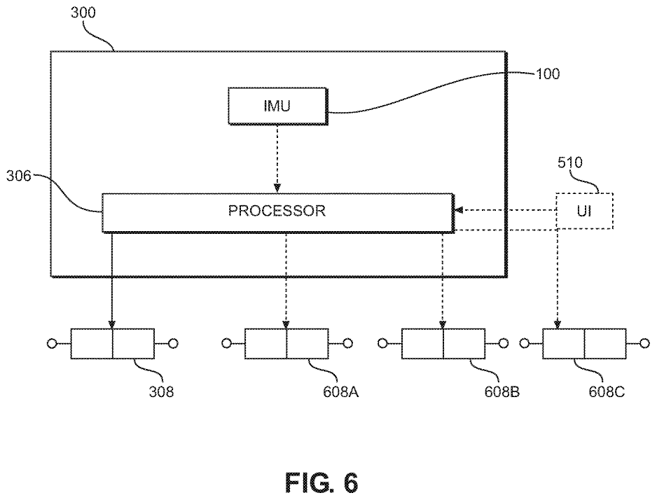

FIG. 6 is a diagram of a suspension control system 300 that receives input from a UI input receiver 510 and has an output to at least one suspension component 608A-C, in accordance with embodiments of the present invention. Also included are second suspension component 608A, third suspension component 608B, and fourth suspension component 608C.

While a total of four suspension components (308, 608A-C) are shown in at least FIG. 6, it should be understood that the number is not intended to be limiting. For example, along with the suspension components at each wheel of a vehicle, other dampers could be included such as the damper(s) for a sway bar, a trailer, etc.

Furthermore, the suspension control data configured for use by a second suspension component 608A coupled to a vehicle is generated by processor 306, wherein the first suspension component 308 and second suspension component 608A are coupled to different locations of the vehicle. Referring now to FIG. 7 an embodiment of suspension control system 300 where processor 306 is integral with an electronic control unit (ECU) 712 is shown. FIG. 7 further depicts various suspension control features such a compression solenoid valve 714, and a rebound solenoid valve 716 which can be used to adjust the settings and damping characteristics of, for example, suspension components 308 and 608A-C. In various embodiment of the present invention, compression solenoid valve 714 is used to adjust the compression characteristics of suspension components 308 and 608A-C while rebound solenoid valve 716 is used to adjust the rebound characteristics of suspension components 308 and 608A-C. For additional detail and description of adjustable compression and/or rebound damping, preload, crossover, bottom-out, and the like for a shock absorber/damper, see, as an example, U.S. Pat. No. 10,036,443 the content of which is incorporated by reference herein, in its entirety.

By adjusting the damping characteristics of a suspension component based upon actual and/or virtualized IMU measurements, embodiments of the present invention achieve enhanced suspension settings and improved vehicle operation. For example, damping characteristics that would have high rider comfort while on a paved road would not be the optimal settings for offroad riding. As such, embodiments of the present invention are able to generate IMU measurements (corresponding to the best vehicle location for IMU placement) and then adjust the damping characteristics of the suspension components based upon the generated IMU measurements. For purposes of the present application, it should be understood that these different damping characteristic settings may be referred to as settings, modes, tunes, or the like.

One benefit of utilizing virtual IMU locations, is that a variety of modes can be established with only a single instance of IMU 100. For instance, If IMU 100 is physically located at location 202A and has virtual locations at 202B-D, then a user can utilize the multiple sets of data for various scenarios. For example, a user may find that a vehicle performs well in turns when adjusted vehicle dynamics data from IMU location 202B is used to adjust the suspension in turns. The user can set a mode that specifically uses the adjusted vehicle dynamics data from location 202B during turns. Similarly, if the user finds the adjusted vehicle dynamics data from location 202C is best over flat rough surfaces, e.g., rocky terrain, then the user can set a mode to use the adjusted vehicle dynamics data from virtual location 202C in such cases.

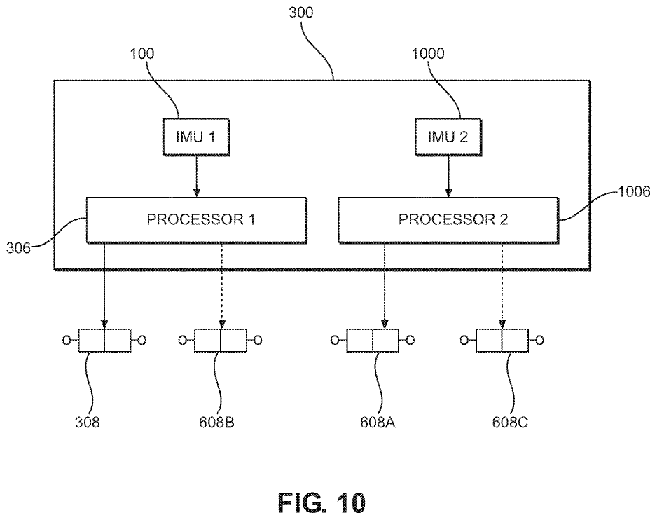

With reference now to FIG. 10, a schematic depiction of an embodiment in which IMU 100 measures vehicle dynamics data for the location on the vehicle corresponding to particular suspension components, 308 and 608B. Additionally, as shown in FIG. 10, IMU 1000 measures vehicle dynamics data for the location on the vehicle corresponding to other suspension components, 608A and 608C. As an example, IMU 100 may be located proximate the front end of vehicle 200 (and front suspension components 308 and 608B), while IMU 1000 is located proximate the rear end of vehicle 200 (and rear suspension components 608A and 608C). In one such embodiment, processor 306 receives the vehicle dynamics data from IMU 100 and generates the suspension control data for suspension components 308 and 608B. Similarly, IMU 1000 receives the vehicle dynamics data from IMU 1000 and generates the suspension control data for suspension components 608A and 608C. Additionally, in various embodiments of the present invention, IMU 100 and IMU 1000 can both send the measured vehicle dynamics data to either the processor 306 or processor 1006 depending on the situation (e.g., which suspension component will receive the suspension control data, which processor is otherwise engaged, etc.).

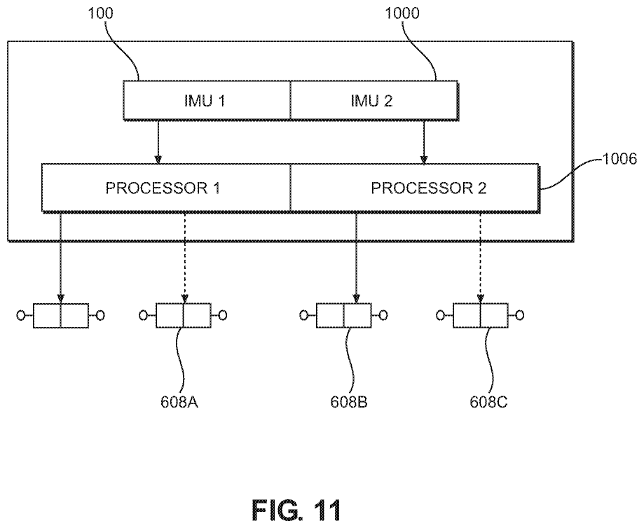

Referring now to FIGS. 3, 10 and 11, it will be understood that embodiments of the present invention are well suited to various implementations of processors and IMU combinations and configurations. For example, in various embodiments, as depicted in FIG. 3, a single processor 306 receives IMU measurements, generates adjusted vehicle dynamics data, generates suspension control data then outputs the suspension control data to one or more suspension components 308. In various other embodiments, as depicted in FIGS. 10 and 11 multiple processors receive IMU measurements from at least one IMU, generate adjusted vehicle dynamics data, generate suspension control data then output the suspension control data to one or more suspension components. Regardless of the specific IMU/processor configuration, embodiments of the present invention generate suspension control data while eliminating the need for a plurality of IMU's to be attached to different locations on the vehicle.

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the Claims.

Reference throughout this document to “one embodiment,” “certain embodiments,” “an embodiment,” “various embodiments,” “some embodiments,” “various embodiments”, or similar term, means that a particular feature, structure, or characteristic described in connection with that embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments can be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What we claim is:

1. A suspension control method utilizing virtual vehicle dynamics data, said suspension control method comprising the steps of:
receiving, at a processor, vehicle dynamics data from an inertial measurement unit (IMU), wherein said IMU is disposed at a first location on a vehicle;
generating, by said processor, said virtual vehicle dynamics data, said virtual vehicle dynamics data corresponding to information which would be received from said IMU provided said IMU was disposed at a second location on said vehicle;
generating, by said processor, suspension control data configured for use by a suspension component, said suspension control data generated using said virtual vehicle dynamics data; and
outputting, from said processor, said suspension control data to said suspension component.

2. The suspension control method as recited in claim 1, wherein said processor:
generates suspension control data configured for use by a second suspension component coupled to said vehicle, wherein said first suspension component and said second suspension component are coupled to different locations of said vehicle.

3. The suspension control method as recited in claim 1, wherein said vehicle dynamics data comprises linear and rotational acceleration data corresponding to said vehicle.

4. The suspension control method as recited in claim 1, wherein said processor is integral with an electronic control unit (ECU) coupled with said vehicle.

5. The suspension control method as recited in claim 1, wherein said processor is integral with said IMU.

6. The suspension control method as recited in claim 1, wherein said processor is integral with said first suspension component of said vehicle.

7. The suspension control method as recited in claim 1, wherein said suspension control data configured for use by said first suspension component causes said first suspension component of said vehicle to adjust a damping characteristic of said first suspension component of said vehicle, wherein said damping characteristic is selected from the group consisting of: a compression characteristic, and a rebound characteristic.

8. The suspension control method as recited in claim 1, wherein said processor is further configured to;
receive said vehicle dynamics data when said IMU is disposed at a first location on said vehicle;
generate adjusted vehicle dynamics data, said adjusted vehicle dynamics data corresponding to information which would be received from said IMU provided said IMU was disposed at a second location on said vehicle;
generate adjusted suspension control data configured for use by said first suspension component, said adjusted suspension control data configured for use by said first suspension component corresponding to said adjusted vehicle dynamics data; and
output said adjusted suspension control data to said first suspension component.

9. The suspension control method as recited in claim 1, further comprising:
utilizing an user interface (UI) input receiver, which is communicatively coupled with said processor, to receive input data and communicate said input data with said processor, wherein said processor is further configured to generate said suspension control data configured for use by said first suspension component utilizing said input data.

10. The suspension control method as recited in claim 1, wherein said processor is further configured to:
generate suspension control data configured for use by a second suspension component, said suspension control data configured for use by said second suspension component corresponding to said vehicle dynamics data; and
output said suspension control data configured for use by said second suspension component.

11. The suspension control method as recited in claim 1, wherein said processor is further configured to:
generate virtual vehicle dynamics data, said virtual vehicle dynamics data corresponding to information which would be received from said IMU provided said IMU was disposed at a second location on said vehicle

12. A suspension control method comprising:
utilizing a first inertial measurement unit (IMU) to measure vehicle dynamics data for a first location on a vehicle to which said first IMU is coupled;
utilizing a second inertial measurement unit (IMU) to measure vehicle dynamics data for a second location on said vehicle to which said second IMU is coupled; and
using a first processor to:
receive said vehicle dynamics data for said first location on said vehicle from at least said first IMU;
generate suspension control data configured for use by a first suspension component, said suspension control data configured for use by said first suspension component corresponding to said vehicle dynamics data for said first location from at least said first IMU; and
output said suspension control data configured for use by said first suspension component.

13. The suspension control method as recited in claim 12, further comprising utilizing said processor to:
receive said vehicle dynamics data for said second location on said vehicle from said second IMU;
generate said suspension control data configured for use by a second suspension component, said suspension control data configured for use by said second suspension component corresponding to said vehicle dynamics data for said second location on said vehicle; and
output said suspension control data configured for use by said second suspension component.

14. The suspension control method as recited in claim 12, further comprising utilizing a second processor to:
receive said vehicle dynamics data for said second location on said vehicle from at least said second IMU;
generate suspension control data configured for use by a second suspension component, said suspension control data configured for use by said second suspension component corresponding to said vehicle dynamics data for said second location on said vehicle from at least said second IMU; and
output said suspension control data configured for use by said second suspension component.

15. The suspension control method as recited in claim 14, wherein at least one of said first processor and said second processor is integral with an electronic control unit (ECU) coupled with said vehicle.

16. The suspension control method as recited in claim 14, wherein at least one of said first processor and said second processor is integral with said first IMU.

17. The suspension control method as recited in claim 14, wherein at least one of said first processor and said second processor is integral with said first suspension component of said vehicle.

18. The suspension control method as recited in claim 12, wherein said suspension control data configured for use by said first suspension component is configured by said first suspension component of said vehicle to adjust a damping characteristic of said first suspension component of said vehicle, wherein said damping characteristic is selected from the group consisting of: a compression characteristic, and a rebound characteristic.

19. The suspension control method of claim 12, wherein said first processor further:
receives said vehicle dynamics data from said first IMU;
generates adjusted vehicle dynamics data, said adjusted vehicle dynamics data corresponding to information which would be received from said first IMU provided said first IMU was disposed at a third location on said vehicle;
generates said suspension control data configured for use by said first suspension component, said suspension control data configured for use by said first suspension component corresponding to said adjusted vehicle dynamics data; and
outputs said suspension control data configured for use by said first suspension component.

20. The suspension control method as recited in claim 12, further comprising:
utilizing a user interface (UI) input receiver communicatively coupled with said first processor to receive input data and communicate said input data with said first processor, wherein said first processor is further configured to generate said suspension control data configured for use by said first suspension component utilizing said input data.
